(19) United States
(12) Patent Application Publication
(10) Pub. No.: US 2026/0194342 A1
(43) Pub. Date: Jul. 9, 2026

(54) AUTOMATION METHOD FOR THIN FILM MEASUREMENT AND ANALYSIS AND APPARATUS FOR THE SAME

(71) Applicant: SAMSUNG ELECTRONICS CO., LTD., Suwon-si (KR)

(72) Inventors: Gahee KIM, Suwon-si (KR); Jun-suk KWAK, Suwon-si (KR); Daewoong HAN, Suwon-si (KR); Jeonghun KIM, Suwon-si (KR)

(73) Assignee: SAMSUNG ELECTRONICS CO., LTD., Suwon-si (KR)

(21) Appl. No.: 19/381,645

(22) Filed: Nov. 6, 2025

(30) Foreign Application Priority Data
Jan. 3, 2025 (KR) 10-2025-0000702

(51) Int. Cl. G01B 11/06; G01N 35/00

(52) U.S. Cl. CPC G01B 11/0641; G01N 35/00693

(57) ABSTRACT

Provided is a method of automating thin film measurement and analysis, and an apparatus for performing same, the method including: generating a recipe including a measurement condition and a thin film analysis model by obtaining information on a material of a thin film; performing a primary analysis, using the thin film analysis model, on a result of a primary measurement of the thin film according to the measurement condition; based on determining that the thin film analysis model is suitable based on a result of the primary analysis, obtaining a final thin film analysis model by updating a parameter of the thin film analysis model using the result of the primary measurement; and outputting a physical property value of the thin film by performing a secondary analysis, using the final thin film analysis model, on a result of a secondary measurement of the thin film according to the measurement condition.

### CROSS-REFERENCE TO RELATED APPLICATION

This application claims priority from Korean Patent Application No. 10-2025-0000702, filed on January 3, 2025, in the Korean Intellectual Property Office, the entire disclosure of which is incorporated herein by reference for all purposes.

### BACKGROUND

### 1. Field

The present disclosure relates to an automation method for thin film measurement and analysis, and an apparatus for the same.

### 2. Description of Related Art

In order to measure and analyze a thin film, the thin film to be analyzed may be generally mounted on a sample stage, a measurement recipe may be created by selecting a measurement condition, an analysis model and the like according to the state of the thin film, and then the measurement may be performed. In this case, the analysis model may be created in advance according to a thin film type and a coating condition.

When the measurement is completed, a model value and an actual measurement value data are compared, and a fitting parameter may have to be changed until the best fit is achieved. In this case, whether fitting reaches an optimal point may be determined by whether the fitting parameter is within an appropriate range, whether a parameter is used appropriately, a minimum mean square error (MSE) value, or the change in refractive index according to a wavelength.

When it is determined that a fitting parameter value alone is insufficient, an alternative model (while the starting model may be the same, and a weight is added based on roughness, composition change (grading), roughness and grading, anisotropy, etc.) may be used for fitting, or the starting model may be changed for fitting.

In most cases, the final thickness may be determined by comparing and confirming the spectrum including a wavelength (x-axis) and psi (or delta) of a model and a measured spectrum. As a result, an intention of an analyst may be involved in the selection of models and variables, the criteria for determining MSE, and the like, and in particular, differences may occur between analysts for the same sample.

### SUMMARY

According to an aspect of the disclosure, a method of automating thin film measurement and analysis includes: generating a recipe including a measurement condition and a thin film analysis model by obtaining information on a material of a thin film; performing a primary analysis, using the thin film analysis model, on a result of a primary measurement of the thin film according to the measurement condition; based on determining that the thin film analysis model is suitable based on a result of the primary analysis, obtaining a final thin film analysis model by updating a parameter of the thin film analysis model using the result of the primary measurement; and outputting a physical property value of the thin film by performing a secondary analysis, using the final thin film analysis model, on a result of a secondary measurement of the thin film according to the measurement condition.

The performing the primary analysis, using the thin film analysis model, on the result of the primary measurement of the thin film may include: obtaining, from the result of the primary measurement of the thin film, a parameter representing a degree of attenuation of an amplitude of polarization of the thin film and a parameter representing a phase difference by wavelength; and obtaining an optical constant associated with the thin film and an error value of the result of the primary analysis of the thin film by inputting the parameter to the thin film analysis model.

The obtaining the final thin film analysis model by updating the parameter of the thin film analysis model may include fitting, based on an error value of the result of the primary analysis of the thin film, a parameter of the thin film analysis model to reduce the error value.

The method may further include: obtaining an analysis result of the result of the primary measurement of the thin film by applying the fitted parameter to the thin film analysis model; and readjusting, based on the error value, the parameter of the thin film analysis model to reduce the error value.

The performing the primary analysis, using the thin film analysis model, on the result of the primary measurement of the thin film may include changing the thin film analysis model in the recipe when a non-standard specification is found in the result of the primary analysis of the thin film.

The generating the recipe including the measurement condition and the thin film analysis model may include selecting the thin film analysis model based on a lookup table categorized according to a material composition of the thin film and a layer structure of the thin film.

The outputting the physical property value of the thin film may include obtaining a first parameter representing a degree of attenuation of an amplitude of polarization of the thin film and a second parameter representing a phase difference by wavelength, and each of the first parameter and the second parameter may be measured at different measurement positions within the thin film a predetermined number of times.

The method may further include: obtaining physical property values for the different measurement positions by inputting the first parameter and the second parameter to the final thin film analysis model; and obtaining an average of the obtained physical property values.

According to an aspect of the disclosure, a non-transitory computer-readable storage medium has instructions stored therein, which when executed by at least one processor, cause the at least one processor to execute a method of automating thin film measurement and analysis, the method including: generating a recipe including a measurement condition and a thin film analysis model by obtaining information on a material of a thin film; performing a primary analysis, using the thin film analysis model, on a result of a primary measurement of the thin film according to the measurement condition; based on determining that the thin film analysis model is suitable based on a result of the primary analysis, obtaining a final thin film analysis model by updating a parameter of the thin film analysis model using the result of the primary measurement; and outputting a physical property value of the thin film by performing a secondary analysis, using the final thin film analysis model, on a result of a secondary measurement of the thin film according to the measurement condition.

With regard to the method executed based on the instructions stored in the non-transitory computer readable storage medium, the performing the primary analysis, using the thin film analysis model, on the result of the primary measurement of the thin film may include: obtaining, from the result of the primary measurement of the thin film, a parameter representing a degree of attenuation of an amplitude of polarization of the thin film and a parameter representing a phase difference by wavelength; and obtaining an optical constant and an error value of the result of the primary analysis of the thin film by inputting the parameter to the thin film analysis model.

With regard to the method executed based on the instructions stored in the non-transitory computer readable storage medium, the obtaining the final thin film analysis model by updating the parameter of the thin film analysis model may include fitting, based on an error value of the result of the primary analysis of the thin film, a parameter of the thin film analysis model to reduce the error value.

With regard to the method executed based on the instructions stored in the non-transitory computer readable storage medium, the method may further include: obtaining an analysis result of the result of the primary measurement of the thin film by applying the fitted parameter to the thin film analysis model; and readjusting, based on the error value, the parameter of the thin film analysis model to reduce the error value.

According to an aspect of the disclosure, an apparatus for automating thin film measurement and analysis includes: memory storing one or more instructions; and one or more processors configured to individually or collectively execute the one or more instructions, wherein the one or more instructions, when individually or collectively executed by the one or more processors, cause the apparatus to: generate a recipe including a measurement condition and a thin film analysis model by obtaining information on a material of a thin film; perform a primary analysis, using the thin film analysis model, on a result of a primary measurement of the thin film according to the measurement condition; based on determining that the thin film analysis model is suitable based on a result of the primary analysis, obtain a final thin film analysis model by updating a parameter of the thin film analysis model using the result of the primary measurement; and output a physical property value of the thin film by performing a secondary analysis, using the final thin film analysis model, on a result of secondary measurement of the thin film according to the measurement condition.

The one or more instructions, when individually or collectively executed by the one or more processors, may further cause the apparatus to perform, using the thin film analysis model, the primary analysis on the result of the primary measurement of the thin film by: obtaining, from the result of the primary measurement of the thin film, a first parameter representing a degree of attenuation of an amplitude of polarization of the thin film and a second parameter representing a phase difference by wavelength; and obtaining an optical constant and an error value of the result of the primary analysis of the thin film by inputting the first parameter and the second parameter to the thin film analysis model.

The one or more instructions, when individually or collectively executed by the one or more processors, may further cause the apparatus to obtain the final thin film analysis model by fitting, based on an error value of the result of the primary analysis of the thin film, a parameter of the thin film analysis model to reduce the error value.

The one or more instructions, when individually or collectively executed by the one or more processors, may further cause the apparatus to: obtain an analysis result of the result of the primary measurement of the thin film by applying the fitted parameter to the thin film analysis model; and readjust, based on the error value, the parameter of the thin film analysis model to reduce the error value.

The one or more instructions, when individually or collectively executed by the one or more processors, may further cause the apparatus to perform the primary analysis, using the thin film analysis model, on the result of the primary measurement of the thin film by changing the thin film analysis model in the recipe when a non-standard specification is found in the result of the primary analysis of the thin film.

The one or more instructions, when individually or collectively executed by the one or more processors, may further cause the apparatus to generate the recipe including the measurement condition and the thin film analysis model by selecting the thin film analysis model based on a lookup table categorized according to a material composition of the thin film and a layer structure of the thin film.

The one or more instructions, when individually or collectively executed by the one or more processors, may further cause the apparatus to output the physical property value of the thin film by obtaining a first parameter representing a degree of attenuation of an amplitude of polarization of the thin film and a second parameter representing a phase difference by wavelength, and each of the first parameter and the second parameter may be measured at different measurement positions within the thin film a predetermined number of times.

The one or more instructions, when individually or collectively executed by the one or more processors, may further cause the apparatus to: obtain physical property values for the different measurement positions by inputting the parameter to the final thin film analysis model; and obtain an average of the obtained physical property values.

According to an aspect of the disclosure, a method of automating thin film measurement and analysis includes: generating a recipe including a measurement condition and a thin film analysis model by obtaining information on a material of a thin film; obtaining a primary measurement of the thin film based on the measurement condition; obtaining a parameter based on the primary measurement; obtaining an error value of the primary measurement by inputting the parameter into the thin film analysis model; based on the error value exceeding a predetermined threshold, obtaining an updated error value by generating an adjusted parameter and inputting the adjusted parameter into the thin film analysis model; iteratively repeating the obtaining the updated error value until a final error value less than the predetermined threshold is obtained; obtaining a final thin film analysis model by updating the thin film analysis model using the adjusted parameter associated with the final error value; and outputting a physical property value of the thin film by performing a secondary analysis, using the final thin film analysis model, on a result of a secondary measurement of the thin film according to the measurement condition.

Additional aspects of the present disclosure are set forth in the description which follows, and will be apparent from the description, or may be learned by practice of the disclosure.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a diagram illustrating a process of automated measurement and analysis according to one or more embodiments;

FIG. 2 is a flowchart illustrating an operation method of an apparatus for generating an image according to one or more embodiments;

FIG. 3 is a flowchart illustrating a measurement and analysis method according to a recipe according to one or more embodiments;

FIG. 4 is a flowchart illustrating a method of fitting a parameter according to one or more embodiments;

FIG. 5 is a flowchart illustrating a method of obtaining a physical property value of a thin film according to one or more embodiments;

FIGS. 6A and 6B illustrate an extended example of measurement and analysis tests according to one or more embodiments; and

FIG. 7 is a block diagram of an apparatus for automating thin film measurement and analysis, according to one or more embodiments.

### DETAILED DESCRIPTION

Hereinafter, one or more embodiments are described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the one or more embodiments with reference to the accompanying drawings, like reference numerals refer to like components and a repeated description related thereto will be omitted. In the description of the one or more embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

The same name may be used to describe an element included in the one or more embodiments described above and an element having a common function. Unless stated otherwise, the description of an embodiment may be applicable to other embodiments, and a repeated description related thereto is omitted.

As used herein, the expressions “at least one of a, b or c” and “at least one of a, b and c” indicate “only a,” “only b,” “only c,” “both a and b,” “both a and c,” “both b and c,” and “all of a, b, and c.”

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

The various actions, acts, blocks, steps, or the like in the flow diagrams may be performed in the order presented, in a different order, or simultaneously. Further, in one or more embodiments, some of the actions, acts, blocks, steps, or the like may be omitted, added, modified, skipped, or the like without departing from the scope of the disclosure.

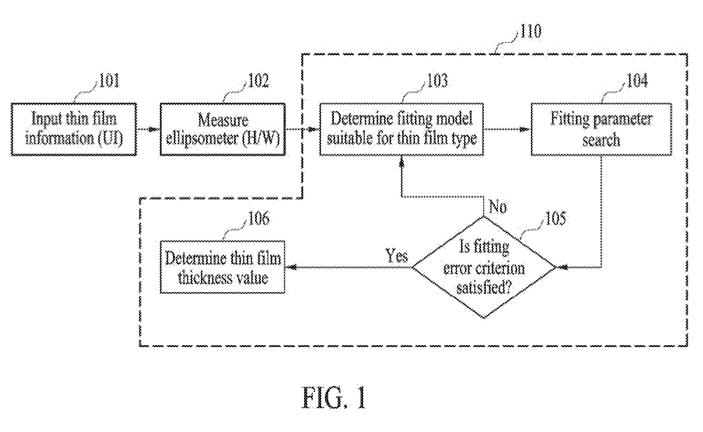

FIG. 1 is a diagram illustrating a process of automated measurement and analysis according to one or more embodiments.

An apparatus for executing a method for automated thin film measurement and analysis may receive information on a material of a thin film in operation 101. The apparatus may receive the information directly from a user through a user interface (UI) of the apparatus or obtain the information through a database that stores the information on the material of the thin film.

The thin film may be, for example, an organic or inorganic metallic thin film having a thickness between a few angstroms and 20 microns and a size between 1.5 millimeters (mm) and 300 mm in diameter.

In operation 102, the measurement of the thin film may be performed. The measurement of the thin film may be performed using a measuring apparatus such as an ellipsometer. The measuring apparatus may include a unit for moving a position and a sample chuck for fixing and supporting a sample, and may measure a thin film based on an input measurement condition.

In operation 110, the apparatus may analyze a physical property of the thin film by determining a model for interpreting a result obtained by measuring the thin film and fitting a model parameter.

It may be possible to generate a large amount of data with high reliability by applying variables that may occur in the optimization process of analyzing a measurement result as well as an error that may occur in hardware during measurement and extracting a result through a series of processes. In addition, by objectifying the variables occurring during measurement and analysis, making an apparatus and an interpretation accessible, and automatically determining the process of measuring and determining the thickness of a thin film and the subsequent processes, it may be possible to make the entire system more precise.

First, in operation 103, a fitting model suitable for the thin film may be identified based on thin film information obtained by the measuring apparatus. The fitting model may be identified from various models to analyze the optical properties of the thin film.

In operation 104, the apparatus may find a fitting parameter. A parameter obtained from the measuring apparatus may be input to the identified model, and a fitting parameter may be found so that an optical value calculated from the identified model is close to the ground truth based on a mean squared error (MSE) or the like, or at least so that the MSE is reduced. The fitting parameter may be found through a process of repeating calculations several times, and the most appropriate fitting parameter may be finally selected within a predetermined number of times.

In the process of finding a fitting parameter, it may be necessary to check whether an MSE is within a standard in operation 105. When a calculation result obtained by a fitting parameter is out of specification, a numerical value of the model, or the model itself, may be changed depending on the result.

In operation 106, the apparatus may determine the thickness of the thin film using the found fitting parameter. Using the found fitting parameter, optimization may be possible between data measured by the measuring apparatus and theoretical calculation data. The thickness of the thin film may be output by applying the fitting parameter to the determined model. Through the determined model, other values representing the physical properties of the thin film, in addition to the thickness, may be calculated.

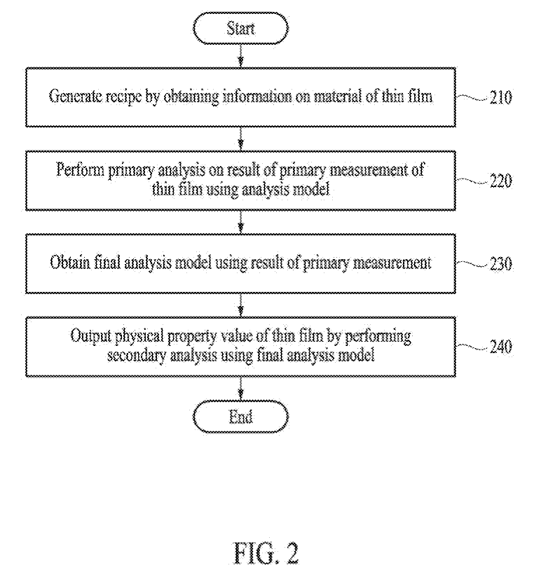

FIG. 2 is a flowchart illustrating an operation method of an apparatus for generating an image according to one or more embodiments.

Operations to be described hereinafter may be performed sequentially. but the disclosure is not limited thereto. For example, the order of the operations may change and at least two of the operations may be performed in parallel.

In operation 210, the apparatus may generate a recipe including a measurement condition and a thin film analysis model by obtaining information on a material of the thin film.

The information on the material of the thin film may include structural information of the thin film such as bare components, presence or absence of an interlayer, components, thickness information, and composition category information of the top layer.

The apparatus may receive the information on the material of the thin film directly from a user through a UI of the apparatus or may obtain the information through a database that stores the information on the material of the thin film.

The recipe may include information about a measurement condition for measuring the thin film and a model for analyzing theoretical data using a measurement result of the thin film.

The analysis model may be selected by referring to the information on the material of the thin film. The analysis model may be selected depending on the material, such as whether the material is a polymer material, cobalt, and the like, or depending on the layer structure, such as whether the layer structure is a single layer or a laminated layer structure of two or more layers. The process of selecting the analysis model may be predetermined based on a rule. For example, for a thin film including a transparent material, a model suitable for analyzing this thin film may be selected, and for a thin film including cobalt among metal materials, a model suitable for analyzing this thin film may be selected. The analysis model may be selected from among, for example, a Cauchy model, a B-spline model, a TiN-Lorentz model, and a TiN hybrid-Lorentz model.

In operation 220, the apparatus may perform, using an analysis model, a primary analysis on a result of primary measurement of the thin film according to a measurement condition.

The apparatus may control the measuring apparatus so that the primary measurement of the thin film is performed according to the measurement condition. For example, the apparatus may include the measuring apparatus or may generate and transmit a control signal to control the measuring apparatus. The control signal may include the measurement condition, for example, information about the position at which the thin film is loaded, information about the position at which the thin film is to be measured, information about a measurement spectrum, the number of measurements, and the like. When the apparatus includes the measuring apparatus, the apparatus may include units for processing each control signal, such as a unit for moving the position of the thin film, a sample chuck for fixing and supporting a sample, and the like.

The apparatus may perform the primary analysis by obtaining the result of the primary measurement and inputting the result to the analysis model. As the result of the primary measurement, the parameter Ψ, which represents the degree of attenuation of the amplitude of the P wave and the S wave for the wavelength irradiated on the thin film in the spectrum, and δ, which represents the phase difference between the P wave and the S wave, may be output.

The apparatus may perform the primary analysis on the thin film by inputting the result of the primary measurement to a selected analysis model. For example, the apparatus may analyze the thin film by inputting Ψ and δ among the parameters of the analysis model as the result of the primary measurement. In this case, as a result of the analysis model, an optical value such as a refractive index by wavelength may be output, and an MSE between theoretical data and measured data and the like may be output.

In operation 230, when it is determined that the analysis model is suitable based on the result of the primary analysis, the apparatus may obtain the final analysis model by updating a parameter of the analysis model using the result of the primary measurement.

Based on the MSE, or error value, among the results of the primary analysis, a parameter for reducing a corresponding error value in the analysis model may be fitted. The fitted parameter may be applied to the analysis model together with the result of the primary measurement, and the model may be analyzed again. An optical value and an error value may be obtained from the analysis result, and based on an error value of a model to which a parameter is fitted, a parameter to be applied to the analysis model may be fitted again.

In summary, by repeating the fitting of a parameter and the analysis of the model to which the fitted parameter is applied, a parameter representing the most minimized error value may be obtained, and the final analysis model may be obtained by applying the parameter.

When it is determined that the result of the primary analysis is not suitable, the analysis model may be changed, and the recipe may be regenerated. For example, when a non-standard specification is found in the analysis result, it may be determined that the analysis model is incorrectly identified, and the analysis model may be changed, or a numerical value of the analysis model may be adjusted in stages.

In the process of fitting a parameter, verification may be performed on an output of the analysis model. When a result output from the analysis model is a non-standard result, the apparatus may change the analysis model or change the numerical value of the analysis model. For example, when an error value gradually decreases as the parameter fitting proceeds but an optical value diverges significantly, the apparatus may determine that the analysis model is incorrectly identified and change the numerical value of the analysis model or change the analysis model itself.

In operation 240, the apparatus may output a physical property value of the thin film by performing a secondary analysis, using the final analysis model, on a result of secondary measurement of the thin film according to the measurement condition.

The apparatus may perform the secondary analysis on the result of the secondary measurement of the thin film using the final analysis model to which a fitted parameter is applied. The secondary analysis may involve using the measurement condition of the recipe and scanning a plurality of different positions in the thin film and produce a measured value for the thin film. The measured value may include Ψ and δ for a wavelength.

The apparatus may perform the secondary analysis by inputting each of a plurality of measurement results to the final analysis model. Therefore, analysis results may be obtained as many times as there are measurements. A physical property value of the thin film may be output as a result of the final analysis model. For example, the result may include property values such as the thickness of the thin film and the refractive index by wavelength. An average of the thickness values output as many times as there are measurements may be calculated to calculate the thickness of the thin film. In this case, an outlier value among the thickness values may be removed and the remaining thickness values may be averaged to produce the final thickness of the thin film.

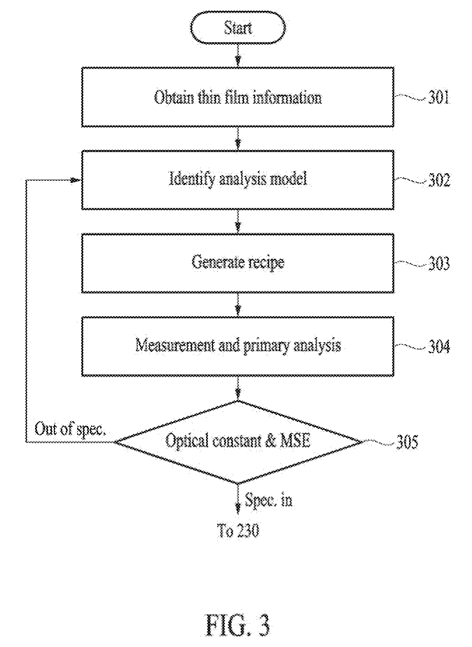

FIG. 3 is a flowchart illustrating a measurement and analysis method according to a recipe according to one or more embodiments.

In operation 301, an apparatus may obtain thin film information.

The thin film information may be information on a material of a thin film and include structural information of the thin film such as bare components, presence or absence of an interlayer, components, thickness information, and composition category information of the top layer.

In operation 302, the apparatus may identify an analysis model.

As described above, the analysis model may be identified based on the information on the material of the thin film. An analysis model that is easy to analyze may be identified based on the information on the material of the thin film.

In operation 303, the apparatus may generate a recipe.

The apparatus may generate a recipe including a suitable measurement condition and an appropriate analysis model based on the information on the material of the thin film. The recipe generated in this way may be generated in a form recognizable by a processor of a measuring apparatus such as an ellipsometer, and when the recipe is transmitted using an interface with the measuring apparatus, the measuring apparatus may be switched to a state in which the measuring apparatus may measure the thin film.

In operation 304, the apparatus may perform primary measurement and a primary analysis.

The primary measurement may be performed by the measuring apparatus, which may be implemented in connection with the apparatus or implemented in the apparatus.

According to the primary measurement, the apparatus may obtain a measurement result for the thin film measured by the measuring apparatus. The measurement result may include an error value such as an optical constant and an MSE corresponding to a measurement wavelength.

In operation 305, the apparatus may check the optical constant and error value to determine whether the result is outside the standard. This determination is intended to verify the analysis model, and the optical constant and error value may serve as criteria for determining whether the analysis model is appropriate for analyzing a thin film.

When the error value exceeds the standard or is significantly different from the theoretical optical constant, the analysis model may be identified again in operation 302. For example, a numerical value of the analysis model may change, or the analysis model itself may change, and the recipe may be regenerated with the changed analysis model.

When the optical constant and error value are within the criteria, a parameter may be fitted using the first measurement result in operation 230.

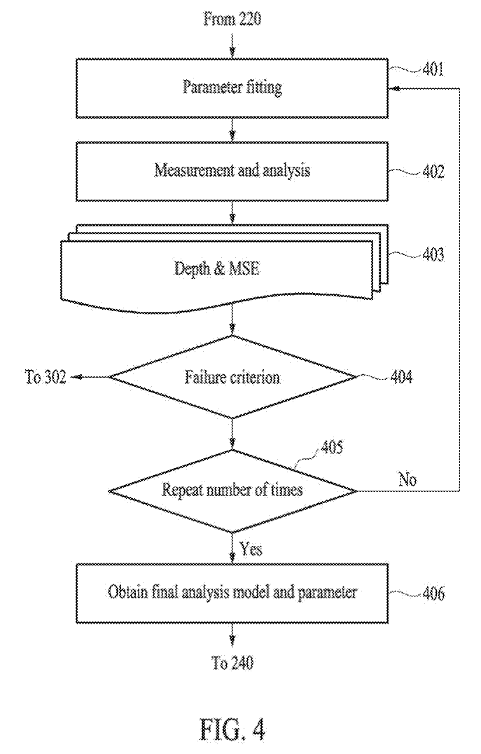

FIG. 4 is a flowchart illustrating a method of fitting a parameter according to one or more embodiments.

Referring to FIG. 4, parameter fitting may be performed through several iterative processes.

In operation 401, an apparatus may fit a parameter.

The apparatus may initiate parameter fitting of an analysis model to reduce an error value of the analysis model. An initial value for parameter fitting may be input.

In operation 402, the apparatus may analyze a measurement result based on the fitted parameter.

The apparatus may reobtain an analysis result by inputting a primary measurement result to the analysis model with the fitted parameter. In the subsequent iteration operations, a plurality of analysis results may be obtained by the analysis model with the fitted parameter for the primary measurement result.

According to operation 403, the analysis results may include thickness information and MSE information of the thin film or may obtain analysis results such as a refractive index.

In operation 404, the apparatus may check whether the analysis results meet a preset failure criterion.

The apparatus may set criteria in advance to verify whether the results output from the analysis model are analysis models that produce meaningful results.

For example, criteria may be set in advance for determining whether parameter fitting is unsuccessful, such as determining whether an optical value increases or decreases linearly, whether there is a pattern of the degree of increase and/or decrease, or whether the MSE gradually decreases or falls below a predetermined reference value.

When the criteria is not satisfied, the analysis model may be changed in operation 302 of FIG. 3.

In operation 405, the apparatus may check whether parameter fitting is repeated a predetermined number of times. For this purpose, the apparatus may use a count function.

For example, when it is determined to repeat parameter fitting 6 times, the series of processes of fitting a parameter, applying the fitted parameter, obtaining analysis results of the analysis model, and comparing the analysis results may be repeated until 6 rounds of parameter fitting are completed.

When a predetermined number of iterations are completed, in operation 406, the apparatus may obtain the final analysis model and a parameter.

The analysis model obtained by a loop and the parameter fitted to the analysis model may be applied as the final analysis model.

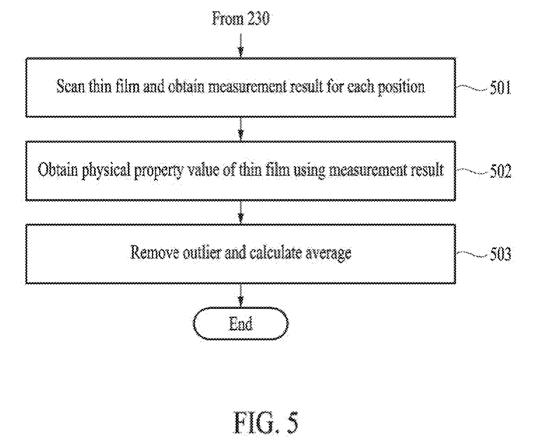

FIG. 5 is a flowchart illustrating a method of obtaining a physical property value of a thin film according to one or more embodiments.

In operation 501, an apparatus may scan the thin film according to a measurement condition and obtain a measurement result for each scan position.

The measurement condition may include a plurality of measurement positions. For example, six different positions within the thin film may be scanned, and measurement results may be obtained for the respective positions. The measurement condition may refer to the measurement condition of a recipe or may be based on a new measurement condition.

In operation 502, the apparatus may obtain physical property values of the thin film using the measurement results.

By inputting the measurement results for the thin film to the final analysis model, the physical property values for the thin film may be obtained. Since a plurality of measurement results are obtained for a plurality of positions and input to the final analysis model, physical property values corresponding to the number of measurement results may be obtained from the final analysis model.

The final analysis model may correspond to a model for which parameter fitting is completed for the determined analysis model, and the method of obtaining the final analysis model is described in detail with reference to FIG. 4.

In operation 503, the apparatus may remove an outlier from the obtained physical property values and calculate an average.

The physical property value that is finally output from the apparatus may be calculated using a plurality of physical property values. A physical property value may include information on the thickness of a thin film, a refractive index by wavelength, and the like.

For example, in order to obtain the thickness information of a thin film, among pieces of thickness information of a plurality of thin films output from the final analysis model, a result corresponding to an outlier may be removed and the average of the remaining thicknesses may be calculated to obtain the final thickness information.

When a refractive index by wavelength is obtained, it may be assumed that the thin film is scanned and measured at a single wavelength under the measurement condition. From the final analysis model, a plurality of refractive indices for a corresponding wavelength may be obtained, and among the obtained refractive index values, a value corresponding to an outlier may be removed, and the average of the remaining refractive indices may be calculated to obtain the refractive index for the corresponding wavelength.

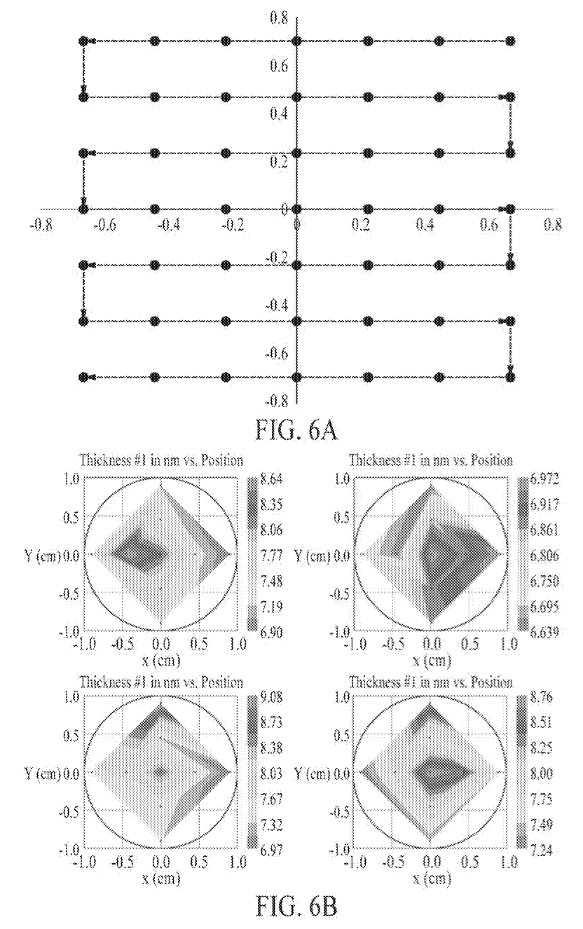

FIGS. 6A and 6B illustrate an extended example of measurement and analysis tests according to one or more embodiments.

FIG. 6A illustrates an example of producing data having high throughput with a high confidence level.

With the automation of thin film measurement and analysis described above, a test to measure and analyze samples of organic/inorganic thin films before and after chemical treatment may be processed at high speed. This allows for obtaining data with a high confidence.

The dots in FIG. 6A represent a plurality of specimens of the same size. Each numerical value is in centimeters (cm). By scanning 49 points of data on a 2x2 silicon wafer piece for a predetermined amount of time, data with high throughput may be obtained. A result may be obtained by measuring and analyzing the point data of each specimen within a short period of time (e.g., 1 minute and 30 seconds). A turnaround time (TAT) may be 0.01 seconds or less compared to manual measurement/analysis/interpretation.

FIG. 6B is an example of testing the applicability of morphology analysis of a thin film by applying data production capability to high throughput data as in FIG. 6A.

By analyzing the representation and microstructure of a thin film through morphology analysis, it may be possible to understood the characteristic and performance of the thin film. Scanning, measuring, and analyzing a silicon wafer thin film using high throughput may provide mapping data that may be used to analyze the homogeneity of the entire thin film.

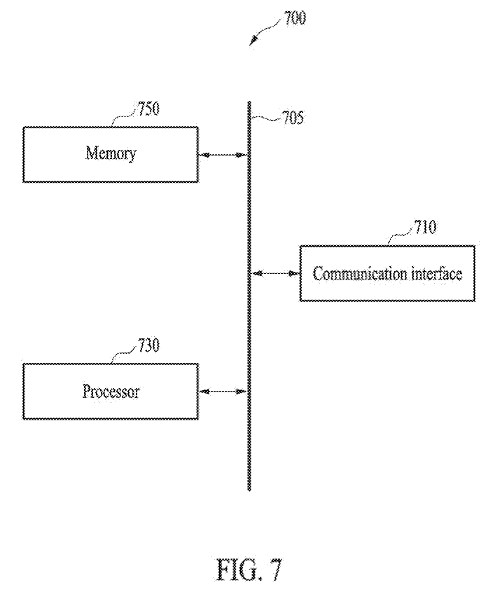

FIG. 7 is a block diagram of an apparatus for automating thin film measurement and analysis, according to one or more embodiments.

Referring to FIG. 7, an apparatus 700 according to one or more embodiments may include a communication interface 710, a processor 730, and a memory 750. The communication interface 710, the processor 730, and the memory 750 may communicate with one another via a communication bus 705.

The communication interface 710 may obtain information on a material of a thin film.

The communication interface 710 may be for transmitting and receiving data by wire or wirelessly and may be implemented as a wireless interface, such as wireless fidelity (Wi-Fi), Bluetooth, Zigbee, and long range (LoRa), a wired interface such as Ethernet, a universal serial bus (USB), or near-field communication (NFC).

The communication interface 710 may include a user interface for receiving an input from a user.

The processor 730 may generate a recipe including a measurement condition and an analysis model based on the information on the material received through the communication interface 710. The processor 730 may analyze the analysis model based on a measurement result measured according to the recipe and determine whether the analysis model is suitable based on an analysis result. The processor 730 may obtain an optimized analysis model by repeatedly fitting a parameter of the analysis model based on the measurement result. The processor 730 may obtain a physical property value from the measurement result of the thin film through an optimized final analysis model.

The memory 750 may store various pieces of information generated in a program and an encoding process for the operation of the processor 730 described above. In addition, the memory 750 may store various types of data and programs. The memory 750 may include a volatile memory or a non-volatile memory. The memory 750 may store a variety of data by including a large mass storage medium, such as a hard disk.

The memory 750 may be implemented as at least one of a volatile memory (e.g.: a dynamic RAM (DRAM), a static RAM (SRAM), or a synchronous dynamic RAM (SDRAM), etc.) or a non-volatile memory (e.g.: an one time programmable ROM (OTPROM), a programmable ROM (PROM), an erasable and programmable ROM (EPROM), an electrically erasable and programmable ROM (EEPROM), a mask ROM, a flash ROM, a flash memory (e.g.: NAND flash or NOR flash, etc.), a hard drive, or a solid state drive (SSD)). In the case of a memory that can be attached to or detached from the electronic apparatus 700, the memory may be implemented in several forms such as a memory card (e.g., compact flash (CF), secure digital (SD), micro secure digital (Micro-SD), mini secure digital (Mini-SD), extreme digital (xD), a multi-media card (MMC), etc.), an external memory that can be connected to a USB port (e.g., a USB memory), etc.

In addition, the processor 730 may perform at least one method described with reference to FIGS. 1 to 7 or an algorithm corresponding to the at least one method. The processor 730 may be a data processing device implemented by hardware including a circuit having a physical structure to perform desired operations. The desired operations may include, for example, code or instructions included in a program. The processor 730 may be implemented as, for example, a central processing unit (CPU), a graphics processing unit (GPU), or a neural network processing unit (NPU). For example, a hardware-implemented prediction apparatus 700 may include, for example, a microprocessor, a CPU, a processor core, a multi-core processor, a multiprocessor, an application-specific integrated circuit (ASIC), and a field programmable gate array (FPGA).

The processor 730 may execute a program and control the apparatus 700. Program code (e.g., one or more instructions) to be executed by the processor 730 may be stored in the memory 750. The processor 730 may be composed of one or more processors. At least one processor 730 may perform the operation of the electronic device 700 according to one or more embodiments by executing at least one instruction stored in the memory 750. At least one processor 730 may include one or more of a central processing unit (CPU), a graphics processing unit (GPU), an accelerated processing unit (APU), a many integrated core (MIC), a digital signal processor (DSP), a natural processing unit (NPU), a hardware accelerator, or a machine learning accelerator. The at least one processor 730 may control one or any combination of other components of the electronic device 700, and may perform an operation or data processing related to communication. At least one processor 730 may individually or collectively execute one or more programs or instructions stored in the memory 750. For example, at least one processor may execute one or more instructions stored in the memory, thereby performing a method according to one or more embodiments of the disclosure.

The methods according to the embodiments described above may be recorded in non-transitory computer-readable storage media including program instructions to implement various operations of the embodiments described above. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs or DVDs; magneto-optical media such as optical discs; and hardware devices that are specially configured to store and perform program instructions, such as ROM, random access memory (RAM), flash memory, and the like. Examples of program instructions include both machine code, such as produced by a compiler, and files containing higher-level code that may be executed by the computer using an interpreter. The hardware devices described above may be configured to act as one or more software modules in order to perform the operations of the embodiments, or vice versa.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method of automating thin film measurement and analysis, the method comprising:
generating a recipe comprising a measurement condition and a thin film analysis model by obtaining information on a material of a thin film;
performing a primary analysis, using the thin film analysis model, on a result of a primary measurement of the thin film according to the measurement condition;
based on determining that the thin film analysis model is suitable based on a result of the primary analysis, obtaining a final thin film analysis model by updating a parameter of the thin film analysis model using the result of the primary measurement; and
outputting a physical property value of the thin film by performing a secondary analysis, using the final thin film analysis model, on a result of a secondary measurement of the thin film according to the measurement condition.

2. The method of claim 1, wherein the performing the primary analysis, using the thin film analysis model, on the result of the primary measurement of the thin film comprises:
obtaining, from the result of the primary measurement of the thin film, a parameter representing a degree of attenuation of an amplitude of polarization of the thin film and a parameter representing a phase difference by wavelength; and
obtaining an optical constant associated with the thin film and an error value of the result of the primary analysis of the thin film by inputting the parameter to the thin film analysis model.

3. The method of claim 1, wherein the obtaining the final thin film analysis model by updating the parameter of the thin film analysis model comprises fitting, based on an error value of the result of the primary analysis of the thin film, a parameter of the thin film analysis model to reduce the error value.

4. The method of claim 3, further comprising:
obtaining an analysis result of the result of the primary measurement of the thin film by applying the fitted parameter to the thin film analysis model; and
readjusting, based on the error value, the parameter of the thin film analysis model to reduce the error value.

5. The method of claim 1, wherein the performing the primary analysis, using the thin film analysis model, on the result of the primary measurement of the thin film comprises changing the thin film analysis model in the recipe when a non-standard specification is found in the result of the primary analysis of the thin film.

6. The method of claim 1, wherein the generating the recipe comprising the measurement condition and the thin film analysis model comprises selecting the thin film analysis model based on a lookup table categorized according to a material composition of the thin film and a layer structure of the thin film.

7. The method of claim 1,
wherein the outputting the physical property value of the thin film comprises obtaining a first parameter representing a degree of attenuation of an amplitude of polarization of the thin film and a second parameter representing a phase difference by wavelength, and
wherein each of the first parameter and the second parameter is measured at different measurement positions within the thin film a predetermined number of times.

8. The method of claim 7, further comprising:
obtaining physical property values for the different measurement positions by inputting the first parameter and the second parameter to the final thin film analysis model; and
obtaining an average of the obtained physical property values.

9. A non-transitory computer-readable storage medium having instructions stored therein, which when executed by at least one processor, cause the at least one processor to execute the method of claim 1.

10. An apparatus for automating thin film measurement and analysis, the apparatus comprising:
memory storing one or more instructions; and
one or more processors configured to individually or collectively execute the one or more instructions,
wherein the one or more instructions, when individually or collectively executed by the one or more processors, cause the apparatus to:
generate a recipe comprising a measurement condition and a thin film analysis model by obtaining information on a material of a thin film;
perform a primary analysis, using the thin film analysis model, on a result of a primary measurement of the thin film according to the measurement condition;
based on determining that the thin film analysis model is suitable based on a result of the primary analysis, obtain a final thin film analysis model by updating a parameter of the thin film analysis model using the result of the primary measurement; and
output a physical property value of the thin film by performing a secondary analysis, using the final thin film analysis model, on a result of secondary measurement of the thin film according to the measurement condition.

11. The apparatus of claim 10, wherein the one or more instructions, when individually or collectively executed by the one or more processors, further cause the apparatus to perform, using the thin film analysis model, the primary analysis on the result of the primary measurement of the thin film by:
obtaining, from the result of the primary measurement of the thin film, a first parameter representing a degree of attenuation of an amplitude of polarization of the thin film and a second parameter representing a phase difference by wavelength; and
obtaining an optical constant and an error value of the result of the primary analysis of the thin film by inputting the first parameter and the second parameter to the thin film analysis model.

12. The apparatus of claim 10, wherein the one or more instructions, when individually or collectively executed by the one or more processors, further cause the apparatus to obtain the final thin film analysis model by fitting, based on an error value of the result of the primary analysis of the thin film, a parameter of the thin film analysis model to reduce the error value.

13. The apparatus of claim 12, wherein the one or more instructions, when individually or collectively executed by the one or more processors, further cause the apparatus to:
obtain an analysis result of the result of the primary measurement of the thin film by applying the fitted parameter to the thin film analysis model; and
readjust, based on the error value, the parameter of the thin film analysis model to reduce the error value.

14. The apparatus of claim 10, wherein the one or more instructions, when individually or collectively executed by the one or more processors, further cause the apparatus to perform the primary analysis, using the thin film analysis model, on the result of the primary measurement of the thin film by changing the thin film analysis model in the recipe when a non-standard specification is found in the result of the primary analysis of the thin film.

15. The apparatus of claim 10, wherein the one or more instructions, when individually or collectively executed by the one or more processors, further cause the apparatus to generate the recipe comprising the measurement condition and the thin film analysis model by selecting the thin film analysis model based on a lookup table categorized according to a material composition of the thin film and a layer structure of the thin film.

16. The apparatus of claim 10,
wherein the one or more instructions, when individually or collectively executed by the one or more processors, further cause the apparatus to output the physical property value of the thin film by obtaining a first parameter representing a degree of attenuation of an amplitude of polarization of the thin film and a second parameter representing a phase difference by wavelength, and
wherein each of the first parameter and the second parameter is measured at different measurement positions within the thin film a predetermined number of times.

17. The apparatus of claim 16, wherein the one or more instructions, when individually or collectively executed by the one or more processors, further cause the apparatus to:
obtain physical property values for the different measurement positions by inputting the parameter to the final thin film analysis model; and
obtain an average of the obtained physical property values.

18. A method of automating thin film measurement and analysis, the method comprising:
generating a recipe comprising a measurement condition and a thin film analysis model by obtaining information on a material of a thin film;
obtaining a primary measurement of the thin film based on the measurement condition;
obtaining a parameter based on the primary measurement;
obtaining an error value of the primary measurement by inputting the parameter into the thin film analysis model;
based on the error value exceeding a predetermined threshold, obtaining an updated error value by generating an adjusted parameter and inputting the adjusted parameter into the thin film analysis model;
iteratively repeating the obtaining the updated error value until a final error value less than the predetermined threshold is obtained;
obtaining a final thin film analysis model by updating the thin film analysis model using the adjusted parameter associated with the final error value; and
outputting a physical property value of the thin film by performing a secondary analysis, using the final thin film analysis model, on a result of a secondary measurement of the thin film according to the measurement condition.
